(19) United States
(12) Patent Application Publication
(10) Pub. No.: US 2008/0240898 A1
(43) Pub. Date: Oct. 2, 2008

(54) Laboratory Robot Assembly

(76) Inventors: Dieter Manz, Schlaitdorf (DE); Berend Oberdorfer, Pliezhausen-Ruebgarten (DE)

Correspondence Address: MICHAEL J. STRIKER, 103 EAST NECK ROAD, HUNTINGTON, NY, 11743, US

(21) Appl. No.: 12/090,329

(22) PCT Filed: Sep. 30, 2006
(86) PCT No.: PCT/EP2006/009507

§ 371 Date: May 28, 2008

(30) Foreign Application Priority Data
Oct. 17, 2005 (DE) 10 2005 049 920.1

(51) Int. Cl. B66F 11/00

(52) U.S. Cl. 414/680; 901/14

(57) ABSTRACT

A laboratory robot assembly for a field of life sciences includes a plurality of robot modules including at least one first robot module having an X-axis arm and at least one Y-axis arm located movably on said X-axis arm in an X direction, the robot modules are located side-by-side in the X direction, each of the robot modules has one X-axis arm and one Y-axis arm, and at least one Y-axis arm of a first robot module is movable at least incrementally along the X-axis arm of an adjacent robot module.

The invention relates to a laboratory robot assembly for the field of life sciences, including at least one first robot module with an X-axis arm, on which at least one Y-axis arm is located movably in the X direction.

In the field of life sciences, automated manipulation of liquids, solids, and objects is necessary. For instance, from a set of specimens, specimens that have specific properties must be removed. The specimens removed have to be either analyzed or added to other specimens. It is also conceivable that specimens may have to be diluted. Other applications are possible and conceivable. Since these operations are often standardized, they should preferably proceed in automated fashion. For that purpose, the most various robot assemblies are already known. Often, the known assemblies are suitable for only a few tasks.

The object of the present invention is to furnish a laboratory robot assembly with which the most various tasks that occur in the field of life sciences can be handled.

According to the invention, this object is attained in a way that is as surprising as it is effective, in that the robot assembly has a plurality of robot modules located side by side in the X direction, and at least one Y-axis arm of a first robot module is movable at least incrementally along the X-axis arm of an adjacent robot module. This provision enhances the modularity of the system. It is furthermore possible for the Y-axis arms to travel over virtually the entire working range. As a result, larger arrays of specimens can be manipulated. The robot assembly can be equipped with a connection to a storage system.

In one embodiment, which is also considered to be an independent invention, it may provided that a coupling device that is movable in the Y direction for coupling a work module is provided on the Y-axis arm. This provision makes it possible to use the robot assembly for various applications. While in the prior art, for instance, robot assemblies are known in which pipetting needles are fixedly installed on a Y-axis arm, and the Y-axis arm can therefore be used solely for pipetting, it is possible with the assembly according to the invention to couple the most various work modules to the Y-axis arms, so that the Y-axis arm can be used variously depending on the work module coupled to it. For instance, a pipetting module or a gripper module may be coupled to it. By changing pipetting modules, pipetting needles can also be replaced faster. The robot assembly of the invention is therefore distinguished by great modularity.

Preferably, adjacent robot modules are connectable to one another. The connection can be made as a snap-in and/or plug-type connection. Adjacent X-axis arms can as a result be joined to make one common X-axis arm and/or can be kept in contact with one another.

To assure an uninterrupted transition from a Y-axis arm to the X-axis arm of an adjacent robot module, it is advantageous if the cable guides, associated with the Y axes, of adjacent robot modules are located in different planes. To enable a transition from a Y-axis arm, it may be necessary to lengthen the coupling device for this Y-axis arm, or to provide a longer coupling device as a standard, or to replace an existing coupling device with a longer one.

The robot modules are especially easy to use and manipulate if they are embodied as a tabletop unit. If larger robot assemblies are needed, a plurality of robot modules can easily be mounted in line with one another.

In an especially preferred embodiment, at least two Y-axis arms may be provided on at least one robot module. For instance, a pipetting module can be provided on a first Y-axis arm, and a gripper module can be provided on a second Y-axis arm. By means of the pipetting module, specimens can for instance be removed from containers, and by means of the gripper module, specimens or containers can be replaced. However, it is also conceivable to provide pipetting modules on both Y-axis arms, making it possible to speed up the handling of a batch, or to handle larger batches.

The usage possibilities are expanded if the work module is movable in the Z direction. To that end, it is preferably embodied as a Z-axis arm or includes a Z-axis arm. However, it is also conceivable for the coupling device to be movable and drivable in the Z direction relative to the Y-axis arm. If the work module is embodied as a Z-axis arm, then another work module can be coupled to it in turn, such as a pipetting module or a gripper module. Alternatively, a Z-axis arm can be provided on the work module that is to be coupled, and this Z-axis arm permits movement of the (other) work module relative to the Y-axis arm in the Z direction. For the pipetting needles of a pipetting module, two adjustment options in the Z direction are therefore obtained, first via the work module relative to the Y-axis arm, and second relative to the work module.

In a preferred refinement, it may be provided that both Y-axis arms have at least one coupling device. As a result, even more different or identical work modules can be coupled and used. This further enhances the modularity and increases the range of possible uses.

In an especially preferred embodiment, it may be provided that at least one Y-axis arm has two coupling devices. Preferably, the coupling devices are movable independently of one another in the Y direction. It is especially preferred if, viewed in the X direction, they are located on different sides of the Y-axis arm and can be driven individually.

In a preferred embodiment of the invention, it may be provided that the coupling device has connections, in particular an electrical connection and/or data connection for the work module to be coupled. Various provisions may be made for being able to secure the work module to the coupling device. For instance, the work module can be flanged on. However, a snap-in connection or a bayonetlike mount may be provided.

To enable actuating the elements of the work module, connections with the rest of the robot assembly or the robot module must be made. In particular, it is advantageous if the work module can be supplied with electrical energy via the robot module. For controlling the work module, it is also advantageous if a data exchange is possible between the work module and a control unit of the robot module or the robot assembly. Preferably, the various connections are made automatically upon coupling of the work module to the coupling device. Aside from the connections mentioned, still other connections may be provided, such as a pneumatic connection or a hydraulic connection.

Preferably, the robot module has a data bus, such as a CAN bus or interbus. It is therefore favorable if the data connection is embodied as a bus interface, and in particular as an interface with a CAN bus or interbus.

The relative motion of the Y-axis arm with respect to the X-axis arm and of the coupling devices with respect to the Y-axis arm is effected preferably via drive mechanisms. Precise positioning is made possible if at least one drive mechanism includes a linear motor. Preferably, all the axis drive mechanisms include a linear motor. Especially if two coupling devices are provided on one Y-axis arm, then two linear motors can make use of the same stator. The coupling devices may be movable either individually, or jointly on one Y-axis arm.

In one embodiment, the work module may be embodied as a pipetting module. This has the advantage that for different specimens, different pipettes, and optionally pipettes with different volumes, can be employed. In comparison to the prior art, the pipettes are therefore easy to replace. Once the pipetting is concluded, the pipetting module can also be replaced with for a different work module.

It is especially preferred if the pipetting module has a plurality of pipetting needle receptacles and/or pipetting needles, which are movable in the Y direction in a limited way relative to the pipetting module, in particular individually. As a result, specimens can be taken simultaneously from different containers that are either of different sizes or have different spacings. The pipetting module can have fixedly installed pipetting needles, with or without a piercing functionality. The provision of pipetting needle receptacles has the advantage that disposable pipettes can be used. Preferably, one pipetting module has more than one, in particular 4, 8, or 12, pipetting needle receptacles and/or pipetting needles. Preferably, the pipetting needle receptacles and/or pipetting needles are movable and adjustable individually in the Y direction.

In particular a laboratory robot assembly for the field of life sciences, including at least one first robot module with an X-axis arm on which at least one Y-axis arm is located movably in the X direction, in which on the Y-axis arm, a coupling device that is movable in the Y direction is provided for coupling a work module, and the work module is embodied as a pipetting module that has a plurality of pipetting needle receptacles and/or pipetting needles that are movable in a limited way relative to the pipetting module, in particular individually, in the Y direction, is considered to be an independent invention.

The spacings between adjacent pipetting needle receptacles and/or pipetting needles can be adjustable, for example in the range from 4-25 mm, and preferably 9-20 mm.

Adjusting the position of the pipetting needle receptacles and/or pipetting needles can be accomplished simply if for the motion of the pipetting needle receptacles and/or pipetting needles In the Y direction, (ball-) spindle drives, piezoelectric drives, or rack drives are provided.

Since the containers may under some circumstances be located in various horizontal positions and/or have various fill levels, it is advantageous if the pipetting needle receptacles and/or pipetting needles are movable, in particular individually, in the Z direction relative to the work module.

In a preferred feature of the invention, for the motion of the pipetting needle receptacles and/or pipetting needles in the Z direction, rack drives, piezoelectric drives, or (ball-) spindle drives are provided.

A pipetting module with one or more of the characteristics recited for a pipetting module is likewise considered to be an independent invention.

In an especially preferred embodiment of the invention, an interchangeable dispenser module may be provided which is connectable to the pipetting needles, in particular fluidically. The pipetting can be done in various ways. For instance, piston stroke pipettes, a micropump, or pipetting via a liquid column may be provided. In most pipetting methods, a dispensing device is necessary that communicates fluidically with the pipettes. To enable using different pipetting methods depending on the pipetting module used, it is advantageous if the dispensing device can be suitably replaced and therefore is likewise embodied as a module.

The robot assembly according to the invention, in particular a robot module of the robot assembly, can be combined with robots made by other manufacturers. However, its use as a tabletop unit is especially advantageous, in which with one pipetting module, a plurality of specimens are taken simultaneously from an array of containers. For that purpose, it is especially advantageous if below the at least one Y-axis arm, a work deck is provided, which can hold the specimens or on which the containers can be set down. Preferably, the work deck is interchangeable and can be secured to a column of the robot module.

The robot assembly can for instance be embodied as a cell that includes an articulated arm robot. Via the articulated arm robot, objects that for instance must be analyzed can be moved. With an articulated arm robot, further degrees of freedom of motion can be achieved. In addition, the Y-axis arms of the robot module can be used predominantly for analysis tasks.

It is especially preferable if a fill level detector is provided for detecting the fill level of a container. It can therefore be assured that a pipetting needle also dips into the liquid that is to be picked up.

Further characteristics and advantages of the invention will become apparent from the ensuing detailed description of exemplary embodiments of the invention in conjunction with the drawings, which show details essential to the invention, as well as from the claims. The individual characteristics may each be implemented alone individually or combined with others in arbitrary combinations in variants of the invention.

In the schematic drawings, exemplary embodiments of the invention are shown that are described in further detail in the ensuing description.

Shown are:

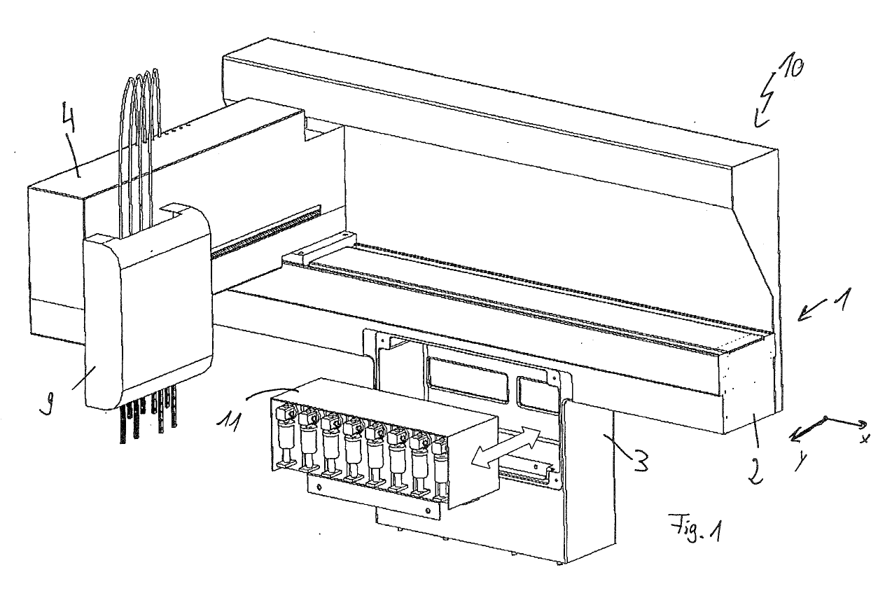

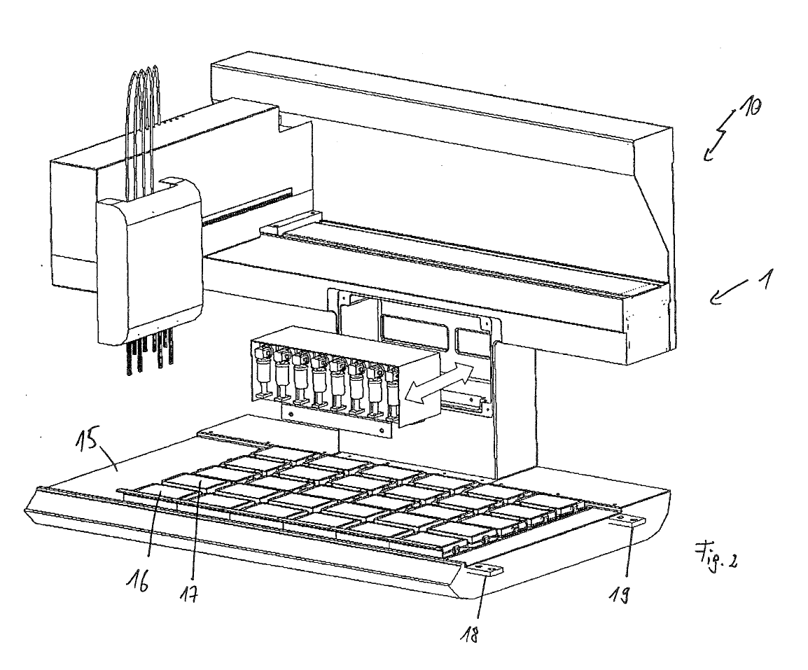

FIG. 1, a perspective view of a robot module of a robot assembly;

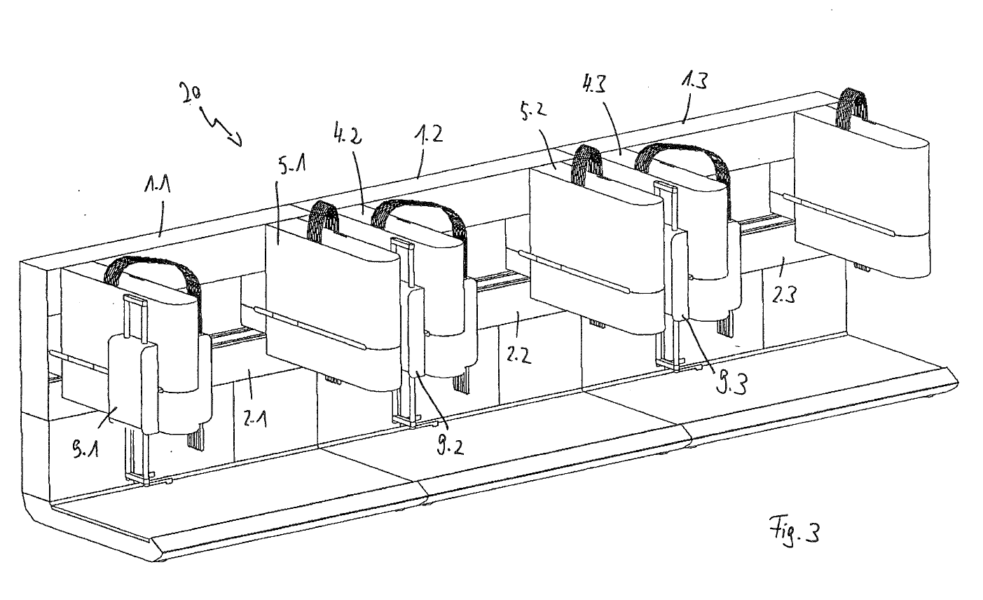

FIG. 2, a perspective view of a robot module with a work deck;

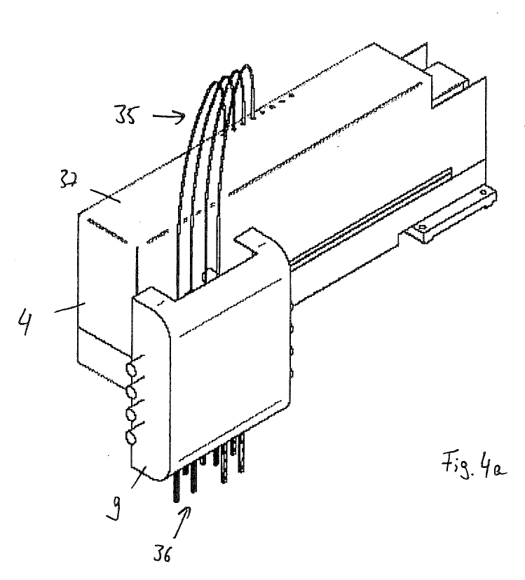

FIG. 3, a view of a robot assembly with a plurality of robot modules;

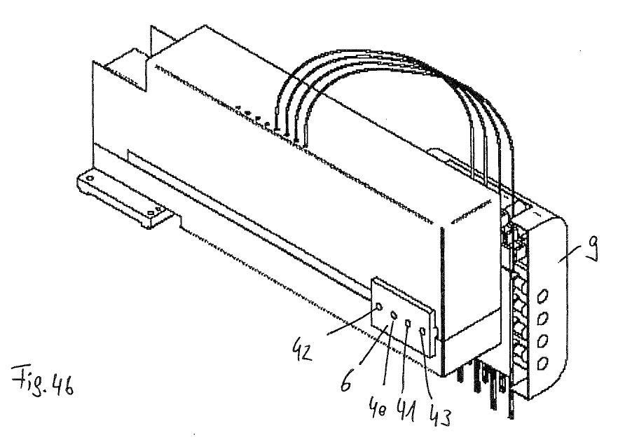

FIG. 4a, a perspective front view of a Y-axis arm;

FIG. 4b, a perspective rear view of the Y-axis arm;

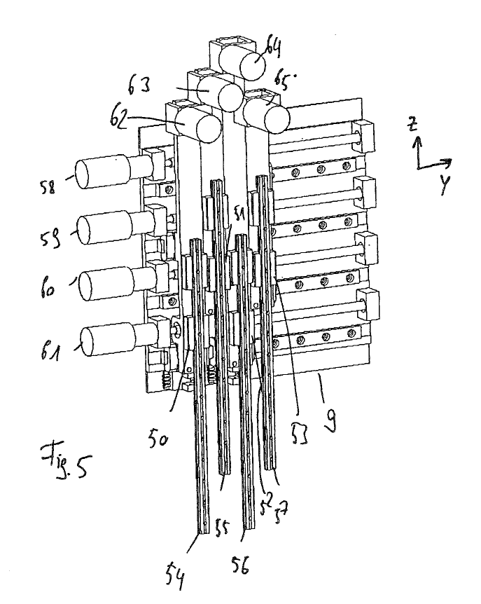

FIG. 5, a view of a pipetting module;

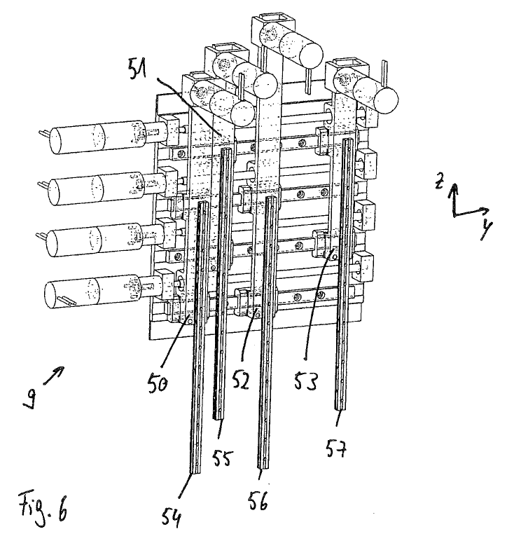

FIG. 6, a further view of a pipetting module.

In FIG. 1, a robot module 1 of a robot assembly 10 is shown. The robot module 1 has an X-axis arm 2, which is secured to a column 3 of the robot module 1. A Y-axis arm 4 is located on the X-axis arm 2, and the Y-axis arm 4 is movable relative to the X-axis arm 2 in the direction of the X axis. The Y-axis arm 4 has two coupling devices 6 (see FIG. 4b), which are suitable for coupling with a work module 9. In the exemplary embodiment, the work module 9 is embodied as a pipetting module. The coupling devices 6 and thus the work module 9 are movable relative to the Y-axis arm 4 in the direction of the Y axes. For moving the coupling devices 6 and the Y-axis arm 4, linear motors are provided, which are located in the axis arms. A dispenser module 11 is located on the column 3 and is connectable to pipetting needles of the work module 9 via flexible tubes.

In a distinction from the view in FIG. 1, the robot assembly 10 of FIG. 2 additionally has a work deck 15, on which various specimens 16, 17 that have to be pipetted can be located. As will be explained in further detail hereinafter, the spacings of the pipetting needles can be adapted to the spacings of the specimens 16, 17. The work deck 15 can be secured to the column 3 and is replaceable. On one end, the work deck 15 has tabs 18, 19, which serve to connect it to an adjacent robot module 1.

In FIG. 3, three identical robot modules 1.1, 1.2, 1.3 are mounted in line with one another, creating a robot assembly 20. The special feature of the robot assembly 20 is that the Y-axis arms 5.1, 4.2, 5.2, 4.3 are movable on the X-axis arms 2.1, 2.2, 2.3 of the respective adjacent robot module 1.1, 1.2, 1.3. The work modules 9.1, 9.2, 9.3 are embodied here as grippers and are movable in the Z direction relative to the associated Y-axis arms.

In the detailed view of the Y-axis arm 4 in FIG. 4a, flexible tubes 35 can be seen, which are connected to the work module 9, and in particular to its pipetting needles 36. On the other end, the flexible tubes 35 extend into a housing 37 of the Y-axis arm 4 and finally reach the dispenser module 11, which is located in the column 3.

In the rear view of FIG. 4b, the coupling device 6 has a plurality of connections 40, 41; the connection 40 is embodied as an electrical connection, and the connection 41 is embodied as a data connection. A work module 9 can be flanged in place via the threaded bores 42, 43.

In FIG. 5, a work module 9 embodied as a pipetting module is shown without any coverings, but only schematically. Pipetting needles 54, 55, 56, 57 are retained in the pipetting needle receptacles 50, 51, 52, 53. The pipetting needle receptacles 50-53 and thus the pipetting needles 54-57 are limitedly movable in the Y direction. The spacings between the pipetting needles 54-57 can therefore be adjusted individually. The adjustability in the Y direction is accomplished by spindle drives 58, 59, 60, 61. The pipetting needle receptacles 50-53 and thus the pipetting needles 54-57 are furthermore adjustable in the Z direction. The adjustment in the Z direction is effected via rack drives 62, 63, 64, 65. The pipetting needles 54-57 are interchangeable. They can be connected fluidically with the dispensing device 11.

From FIG. 6, it becomes clear that the pipetting needle receptacles 50-53 and thus the pipetting needles 54-57 are adjustable individually and independently of one another in both the Y direction and the Z direction. In particular, different spacings between the pipetting needle receptacles 50-53 in the Y direction can be attained.

1-27. (canceled)

28. A laboratory robot assembly for a field of life sciences, comprising a plurality of robot modules including at least one first robot module having an X-axis arm and at least one Y-axis arm located movably on said X-axis arm in an X direction, said robot modules being located side-by-side in the X direction, each of said robot modules having one said X-axis arm and one said Y-axis arm, and at least one said Y-axis arm of a first one of said robot modules being movable at least incrementally along said X-axis arm of an adjacent one of said robot modules.

29. A laboratory robot assembly as defined in claim 28; and further comprising a coupling device which is movable in a Y direction for coupling a work module and which is provided on said Y-axis arm.

30. A laboratory robot assembly as defined in claim 28, wherein adjacent ones of said robot modules are connectable to one another.

31. A laboratory robot assembly as defined in claim 28, wherein adjacent ones of said robot modules have cable guides which are associated with Y axes and located in different planes.

32. A laboratory robot assembly as defined in claim 28, wherein at least one of said robot modules is configured as a tabletop unit.

33. A laboratory robot assembly as defined in claim 28, wherein at least one of said robot modules is provided with at least two Y-axis arms.

34. A laboratory robot assembly as defined in claim 33, wherein said two Y-axis arms have at least one coupling device.

35. A laboratory robot assembly as defined in claim 28, wherein at least one said Y-axis arm has two coupling devices.

36. A laboratory robot assembly as defined in claim 35, wherein said coupling devices of said Y-axis arm are movable in a Y direction independently of one another.

37. A laboratory robot assembly as defined in claim 34, wherein said coupling device has connections for a work module to be coupled.

38. A laboratory robot assembly as defined in claim 37, wherein said connections are connections selected from the group consisting of an electrical connection, a data connection, and both.

39. A laboratory robot assembly as defined in claim 38, wherein said data connection is configured as a bus interface.

40. A laboratory robot assembly as defined in claim 39, wherein said bus interface is selected from the group consisting of an interface with a CAN bus and interbus.

41. A laboratory robot assembly as defined in claim 28; and further comprising drive mechanisms provided at a location selected from the group consisting of in said axis arms and on said axis arms, at least one of said drive mechanisms including a linear motor.

42. A laboratory robot assembly as defined in claim 29, wherein said work module is configured as a pipetting module.

43. A laboratory robot as defined in claim 42, wherein said pipetting module has a plurality of elements selected from the group consisting of pipetting needle receptacles, pipetting needles, and both, which are movable in a Y direction in a limited way relative to said pipetting module.

44. A laboratory robot as defined in claim 43, wherein said elements selected from the group consisting of pipetting needle receptacles, pipetting needles, and both are movable in the Y direction individually.

45. A laboratory robot as defined in claim 43, wherein said elements selected from the group consisting of pipetting needle receptacles, pipetting needles and both are arranged so that spacings between said elements are adjustable.

46. A laboratory robot as defined in claim 45, wherein said elements are arranged so that the spacings between said elements are adjustable in a range from 4 to 25 mm.

47. A laboratory robot as defined in claim 46, wherein said elements are arranged so that the spacing between said elements are adjustable in the range from 9 to 20 mm.
